(19) United States
(12) Patent Application Publication
(10) Pub. No.: US 2014/0344127 A1
(43) Pub. Date: Nov. 20, 2014

(54) NETWORK-BASED ELECTRONIC INVOICING SYSTEM WITH REVERSE INVOICING

(71) Applicant: Daniel B. Thomas, San Francisco, CA (US)

(72) Inventor: Daniel B. Thomas, San Francisco, CA (US)

(21) Appl. No.: 14/353,228

(22) PCT Filed: Oct. 22, 2012
(86) PCT No.: PCT/US12/61369

§ 371 Date: Apr. 21, 2014

Related U.S. Application Data
(60) Provisional application No. 61/550,299, filed on Oct. 21, 2011.

(51) Int. Cl. G06Q 30/04

(52) U.S. Cl. CPC G06Q 30/04
USPC 705/34

(57) ABSTRACT

A system and method for performing network-based electronic invoicing with reverse invoicing. An invoice creation screen is presented to a client user, through a client device connected via a network to an electronic invoicing system. The method includes accepting invoice data input by the client user via the invoice creation screen. The method further includes generating a first invoice document based on the invoice data input by the client user, the first invoice document including an invoice identifier and the amount payable. The first invoice document is presented to the client user on an invoice review screen which includes an actuator to post the first invoice document to an account of the vendor user. The first invoice document is presented to the vendor user on an invoice approval screen which includes actuators to approve the first invoice document or to contest the first invoice document.

### CROSS-REFERENCE TO RELATED APPLICATIONS

This is a U.S. national stage of application No. PCT/US2012/061369, filed on Oct. 22, 2012, which claims priority to, and the benefit of, U.S. Provisional Patent Application No. 61/550,299, filed Oct. 21, 2011, which are both hereby incorporated by reference in their entireties.

### FIELD OF THE INVENTION

The present invention is directed to a network-based electronic invoicing system with reverse invoicing. More specifically, the invention is directed to a system which includes invoices created by client users for goods and/or services rendered, or to be rendered, to the client user by a vendor user.

### BACKGROUND OF THE INVENTION

Online “e-invoicing” significantly reduces invoicing expenses. The U.S. Treasury Department's e-invoicing system, for example, is projected to save 50%, or $450 million, in 2013. Industry leader Basware claims their system saves clients up to 90% on paper invoicing costs. However, their systems still rely on vendors-generated invoices that are often delayed, require cross-checking/validation and dispute resolution, and have significant data entry/scanning costs. Online payment systems for businesses are struggling to meet client demand for more efficient, secure, and reliable payment services with greater cost savings. In the $4.5B e-invoicing industry, there are 7.75M users, more than 90% of whom are small and medium enterprises (SMEs) that issue fewer than 1000 invoices per month.

### SUMMARY OF THE INVENTION

The disclosed embodiments provide a system in which vendors are removed from the traditional responsibility of sending invoices—the clients send invoices to the vendors instead. Invoices sent in this manner may be referred to as a “reverse invoice” or “RI”. An RI system (RIS), cloud-based SaaS (Software-As-A-Service) application that requires clients to submit invoices to their vendors (e.g., service providers) efficiently reduces invoicing delays while eliminating cross-checking, and expensive exception-correction procedures. It is not only more efficient, saving invoicers a significant amount of money over conventional approaches, but also rationalizes invoicing by bringing more predictability to the payment process.

Using RIS, clients can speed up the invoicing process and save significant amounts of money on invoicing costs by eliminating invoice cross-checking, return invoice costs, and “system drag” waiting for vendor invoices. Rapid processing is enhanced by an innovative instant messaging platform and a mobile network (“BTN”) that revolutionizes the vendor-Client dialogue.

The business sectors in which such a system may be used include management consulting, accounting, advertising and marketing, and other business services SMEs. These sectors could see immediate financial benefits using the reverse invoice process.

The disclosed embodiments provide a method, system, and computer-readable medium for performing network-based electronic invoicing with reverse invoicing. The method includes presenting an invoice creation screen to a client user, through a client device connected via a network to an electronic invoicing system, the client user being logged-in to the electronic invoicing system. The method further includes accepting invoice data input by the client user via the invoice creation screen, the invoice data including an identifier of a vendor user and an amount payable by the client user to the vendor user for goods and/or services rendered, or to be rendered, to the client user by the vendor user in connection with a first invoice. The method further includes generating a first invoice document, corresponding to the first invoice, based on the invoice data input by the client user, the first invoice document including an invoice identifier and the amount payable. The method further includes presenting the first invoice document to the client user on an invoice review screen which includes an actuator to post the first invoice document to an account of the vendor user. The method further includes presenting the first invoice document to the vendor user on an invoice approval screen which includes actuators to approve the first invoice document or to contest the first invoice document.

Certain embodiments may include one or more of the following features. If the vendor user approves the first invoice document, the first invoice document may be presented to the client user with an approval indication. If the vendor user approves the first invoice document, the first invoice document may be presented to the client user with an actuator to close a project corresponding to the first invoice document. After the client user closes the project corresponding to the first invoice document, the first invoice document may be presented to the vendor user with actuators to approve the first invoice document or to contest the first invoice document. If the vendor user approves the first invoice document after the project is closed, the first invoice document may be presented to the client user with an approval indication and the first invoice document is entered in a payment queue.

### BRIEF DESCRIPTION OF THE DRAWINGS

The above and other objects and advantages of the disclosed subject matter will be apparent upon consideration of the following detailed description, taken in conjunction with accompanying drawings, in which like reference characters refer to like parts throughout, and in which:

FIG. 1 is a block diagram of a network configuration for an electronic invoicing system with reverse invoicing, in accordance with an embodiment of the invention.

FIG. 2 depicts an example of possible submission, revision, and approval paths for an invoice and examples of typical corresponding time periods for each path of a reverse-invoicing process.

FIGS. 3A-3B are a flowchart of the electronic invoicing system with reverse invoicing which shows the actions of the client user and vendor user in the various phases of invoice submission, revision, and approval in a reverse-invoicing process.

FIG. 4 depicts an account summary screen for the client user of the electronic invoicing system, which summarizes the status of the client user's invoices and presents an activity window showing invoice-correlated messages.

FIG. 5 depicts an invoice creation screen which allows the client user to input invoice data to generate an invoice document.

FIG. 6 depicts a generated invoice document in Phase I of the reverse-invoicing process based on the invoice data input by the client user.

FIG. 7 depicts an invoice document in Phase I of the reverse-invoicing process after the client user has posted the invoice to the vendor user.

FIG. 8 depicts an account summary screen for the vendor user of the electronic invoicing system, which summarizes the status of the vendor user's invoices and presents an activity window showing invoice-correlated messages.

FIG. 9 depicts an invoice document in Phase I of the reverse-invoicing process as it appears to the vendor user for approval after the client user has posted the invoice to the vendor user.

FIG. 10 depicts an invoice document in Phase II of the reverse-invoicing process as it appears to the vendor user after the vendor user has approved the invoice in Phase I.

FIG. 11 depicts an invoice document in Phase II of the reverse-invoicing process as it appears to the client user for closing of the project after the vendor user has approved the invoice in Phase I.

FIG. 12 depicts an invoice document in Phase III of the reverse-invoicing process as it appears to the client user after the client user has closed the project corresponding to the invoice in Phase II.

FIG. 13 depicts an invoice document in Phase III of the reverse-invoicing process as it appears to the vendor user for approval after the client user has closed the project corresponding to the invoice in Phase II.

FIG. 14 depicts an invoice document in Phase IV of the reverse-invoicing process as it appears to the vendor user after the vendor user has approved the invoice in Phase III.

FIG. 15 depicts an invoice document in Phase IV of the reverse-invoicing process as it appears to the client user after the vendor user has approved the invoice in Phase III and the invoice has entered the payment queue.

FIG. 16 depicts an invoice document in Phase I of the reverse-invoicing process as it appears to the vendor user after the vendor user has indicated that the invoice is to be contested.

FIG. 17 depicts an invoice document in Phase I of the reverse-invoicing process as it appears to the vendor user after the vendor user has posted the contested invoice back to the client user.

FIG. 18 depicts an invoice document in Phase I of the reverse-invoicing process as it appears to the client user after the vendor user has posted the contested invoice back to the client user.

FIG. 19 depicts an invoice document in Phase I of the reverse-invoicing process as it appears to the client user as it is being revised after the vendor user has posted the contested invoice back to the client user.

FIG. 20 depicts an invoice document in Phase I of the reverse-invoicing process as it appears to the client user after the revised invoice has been posted to the vendor user.

FIG. 21 depicts a menu allowing selection of query types for an Accounts Payable report and payment predictions for reverse invoices.

FIG. 22 depicts a query parameter entry screen for Accounts Payable predictions for reverse invoices.

FIG. 23 depicts an Accounts Payable prediction report for reverse invoices.

### DETAILED DESCRIPTION

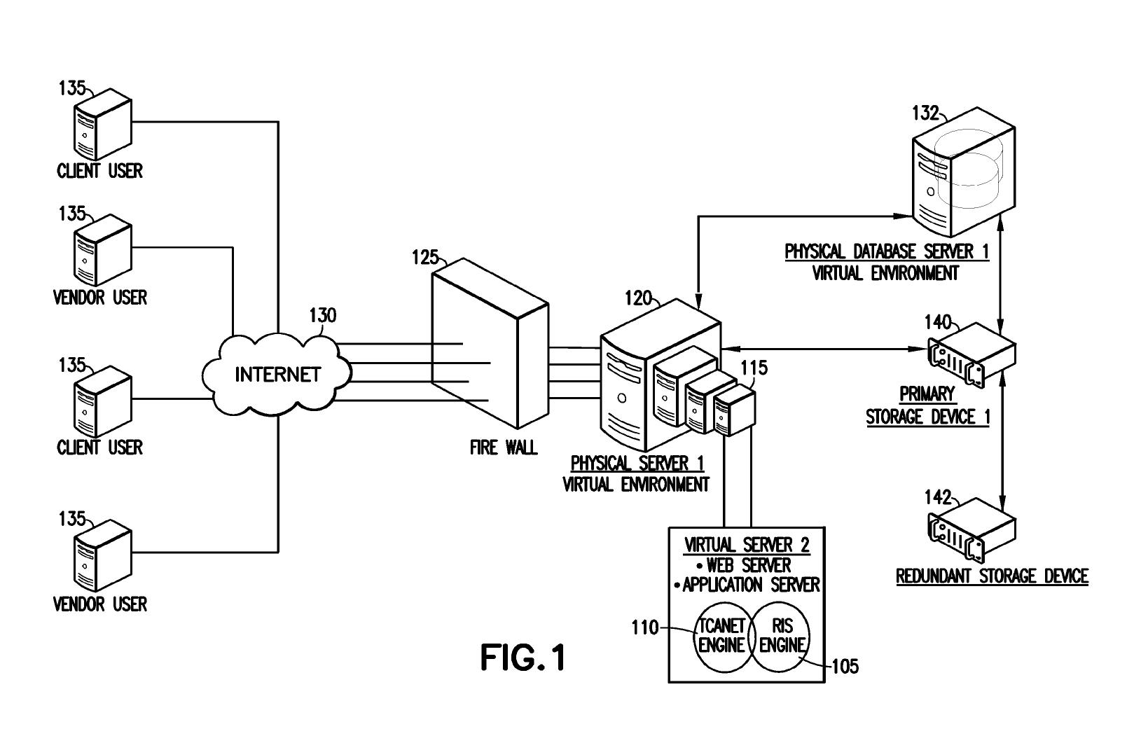

FIG. 1 is a block diagram of a network configuration for an electronic invoicing system with reverse invoicing, in accordance with an embodiment of the invention. A reverse invoicing system (RIS) is a system that clients use to generate invoices for the vendors who provide them with business services. Instead of the vendors generating invoices which they submit to clients for payment, the RIS reverses the practice, such that clients are generating and submitting invoices to their vendors for their approval. Clients generate vendor invoices for the vendors, and the client controls both the information included in the invoice and when the invoice is submitted to the vendors. The RIS is an invoicing system that has the following functions/features:

(1) creates invoices for the vendors providing services (versus conventional invoicing in which vendors create their own invoices);

(2) early payment estimates by viewing invoices for projects that have not closed (versus conventional approaches in which vendors see invoices only after they have created them and after project closure);

(3) early warnings of delayed vendor payouts and cash flow issues (versus conventional approaches in which clients waiting for vendor invoices cannot anticipate when payments move to payment queue);

(4) analysis of vendor invoice approval trends in order to produce more accurate predictions for when invoices enter payment queue; and

(5) choice of prediction analysis types, e.g., average analysis or probability analysis.

An online project management system, has been developed to aid business owners and project managers (i.e., “client users”) manage projects involving vendors (i.e., “vendor users”) who provide business services and/or goods. The system is a document management engine and project search engine. It also includes vendor user and client user databases where contact, vendor rate, quantity of work, and other project information is stored. The client user's project managers (PMs) add information to the database with every new project they open. RIS draws data from these databases to generate vendor invoices it later makes available to the vendor users via a vendor user's terminal device connected to the system via a network, e.g., the Internet.

The project management system generates a personal login page for each client user and vendor user. The personal login pages display information and document links for projects a client user or vendor user is involved in and invoice information that has been generated and submitted. Client-user pages display project information and provide access to RIS analyses and reporting functions. Even though RIS is designed to generate invoices and user-login pages from information in the project management system database, the RIS system can operate as a stand-alone system or an application on a SAAS network as well. As a standalone system or SAAS tool, RIS is capable of generating project data input pages for each project, login pages for users, analyzing data and generating reports.

FIG. 1 depicts an example of a network configuration, which shows how the system is configured with the RIS engine 105 existing within the project management system 110 environment in a virtual server 115. As a standalone system, the RIS engine 105 could exist in virtual server 115 without the project management system engine 110. The virtual server 115 is hosted in a physical server 120, which is connected through a firewall 125 to a network, e.g., the Internet 130. The physical server 120 may be connected to a physical database server 132 or a database may be hosted by the physical server 120 itself. The database may employ a primary storage device 140 and a redundant storage device 142. The virtual server 115 is connected via this network configuration to a number of client user devices 135 and vendor user devices 140.

Client users have the permission to manually open and close a project with the click of the OPEN or CLOSE button in a Project Set-up page in the project management and RIS systems. When a client user manually closes a project, RIS detects the closed project and then deploys or “submits” the project's generated invoices. Each vendor user has a personal login page in the RIS or project management systems. RIS forwards it to the login page of each vendor user who participated in the job for approval. On their personal login pages the PM client users receive notices indicating which invoices have been submitted to vendor users and which have not.

After the project is closed and the invoices submitted, RIS monitors and analyzes each vendor user's electronic responses. As explained in further detail below, each vendor user is prompted by RIS to select one of the following response choices available to the vendor user when addressing each invoice on their webpage: ACCEPT, CONTEST, or NO ACTION (not to act). When viewed in the system, the invoices include two actuators, e.g., clickable buttons, representing choices to ACCEPT or CONTEST the invoice. The third, default option is not to act on the invoice, or NO ACTION.

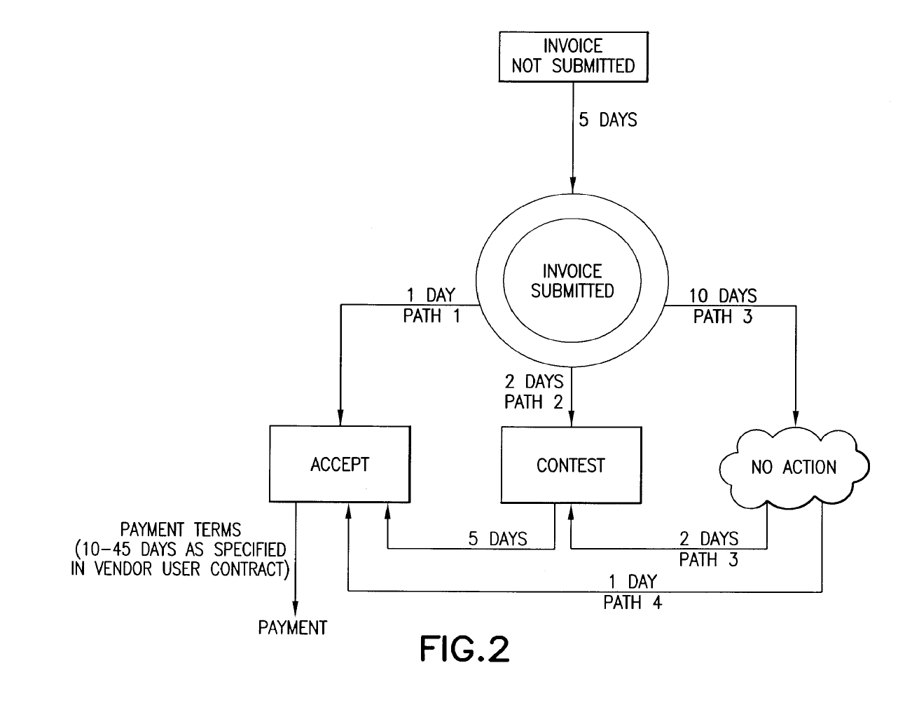

FIG. 2 depicts an example of possible submission, revision, and approval paths for an invoice and examples of typical corresponding time periods for each path of a reverse-invoicing process. The diagram shows the paths to payment for each choice a vendor user makes after the project is closed, the previously generated invoice is submitted, and the invoice appears in each vendors personal webpage. RIS tracks the time interval between submission of the invoice and acceptance of the invoice by the vendor user. Only after the system receives an ACCEPT signal from a clicked ACCEPT button (i.e., after the ACCEPT actuator has been actuated), will the invoice be sent to the client user's payment queue, at which point the client user's accounts payable system is expected to act and make payment to the vendor user according to previously agreed upon payment terms.

To “accept” an invoice means the vendor user has agreed to the amount of payment specified in the invoice. To accept an invoice in RIS, the vendor user must check the box next to the legal statement verifying their agreement with the payment amount, terms and conditions of payment. They then must click the ACCEPT button which signals RIS to send the invoice to the payment queue.

When the vendor user approves of an invoice and makes the ACCEPT choice, RIS ceases to monitor progress (approval) of the invoice and places it in the payment queue to be paid by the client user. Once the invoice is placed in the payment queue, RIS records in the database the number of days between submission to the vendor user and acceptance by the vendor user. For the purpose of this example, immediate acceptance occurs one day after it is submitted to the vendor user (see FIG. 2, Path 1).

If the vendor user chooses to contest the submitted invoice, it may take the vendor user, for example, two days to decide to dispute or reject the invoice and confront the client user. The rejection could be for whatever reason the vendor user decides, including incorrect payment amount, incorrect description, incorrect vendor user information, etc. To dispute the invoice, the vendor user must click the CONTEST button in the appropriate invoice screen. RIS continues to track the invoice in this case. It may take an additional five days for the vendor user and client user to resolve the matter. (see FIG. 2, Path 2). This delays progression of the invoice through the process by, for example, five more days. If the vendor user and client user resolve the issue, the client user revises the invoice (if necessary) and resubmit it to the vendor user who then clicks “Accept.” The vendor user must then check the terms and conditions checkbox, and click the “Accept” button, which signals RIS to send the invoice to the payment queue. If that occurs, for example, on the seventh day, RIS records the time and ceases to monitor time between submission and acceptance and records in the database that acceptance occurred on the seventh day for this contested invoice.

“No Action” occurs on an invoice occurs the vendor user neither immediately accepts nor contests the invoice, but simply ignores or overlooks the invoice that appears in their portal webpage. No action is required by the vendor user for an invoice to gain this designation. This is the default designation given all invoices after they are submitted and before the vendor user chooses an action. A period of, for example, ten days or more may lapse until the vendor user notices the invoice in their portal webpage. RIS tracks this time. After the vendor user decides to respond to the invoice, they can then choose to accept the invoice or contest the invoice. To accept, the vendor user must follow the procedure of checking the terms and conditions checkbox and clicking the ACCEPT button on the appropriate invoice screen. When they accept, this signals RIS to send the invoice to the payment queue. RIS then ceases to monitor time between submission and acceptance and records in the database that acceptance occurred on the eleventh day for this NO ACTION invoice. FIG. 2, Path 3, depicts how the NO ACTION choice followed by acceptance results in an eleven-day time interval between submission and placement in the payment queue, in this example.

However, if after a period of NO ACTION, the vendor user decides to contest the invoice, then there is additional delay tracked by RIS. RIS may then observe, for example, a two-day delay when the vendor user decides to dispute the invoice and clicks the CONTEST button. The contesting of the invoice may occur on the twelfth day. It may take another five days for the vendor user and client user to resolve the issue (see FIG. 2, Path 4). This delays progression of the invoice through the process five more days, according to this example. If the vendor user and client user resolve the issue 17 days after submission of the invoice, then the client user revises (if necessary) and resubmits the invoice. The vendor user must then check the terms and conditions checkbox, and click the ACCEPT button, which signals RIS to send the invoice to the payment queue. As with the other choice paths, RIS then ceases to monitor time between submission and acceptance and records in the database that acceptance occurred, in this case, on the 17th day for this invoice.

The time interval for accepting the invoice is the shortest in this example. The NO ACTION default choice describes the longest path to payment in this example. The choices eventually lead to payment even if there is NO ACTION for a period of time. The differences in time intervals between the two response choices (i.e., accept or contest) and the default choice (i.e., no action) can significantly impact the client user's cash flow. Also, these differences are conventionally based solely on manager observations.

RIS logs the choices and the corresponding real time intervals to payment for each invoice. Each vendor user provides historical data each time they make invoice choices. This information is stored in the database for later analysis. RIS uses its invoice analyses engine to generate Accounts Payable (AP) reports, as discussed in further detail below. The reports provide information about the client user's actual expenses and cash flow positions.

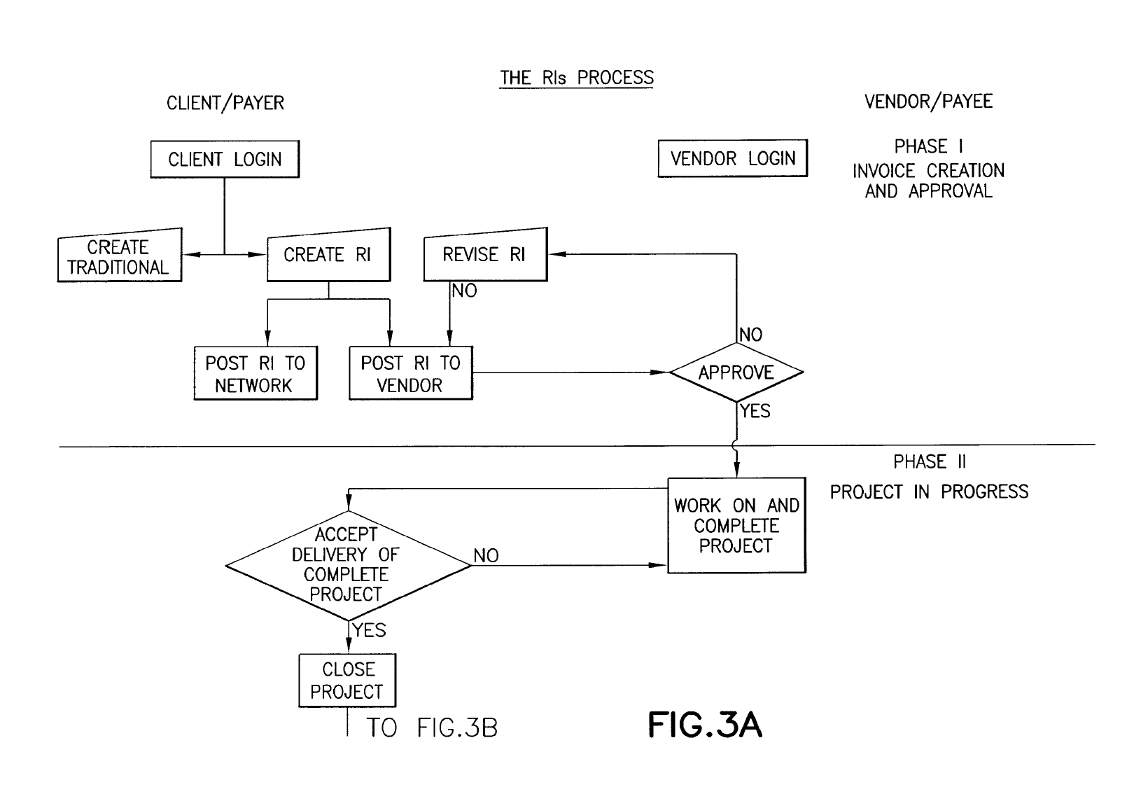

FIGS. 3A-3B are a flowchart of the electronic invoicing system with reverse invoicing which shows the actions of the client user and vendor user in the various phases of invoice submission, revision, and approval in a reverse-invoicing process. The various steps performed by the client user in each phase of the reverse-invoicing process are depicted on the left side of the diagram, and the steps performed by the vendor user are depicted on the right side of the diagram. Phase I involves creation of a reverse invoice by a client user and submission to a vendor user for approval. Phase II involves the performance of a project corresponding to the invoice by the vendor user, i.e., the production and/or preparation of goods and/or services to be delivered to the client user. This phase continues until the goods and/or services are delivered to the client user and found to be acceptable, at which point the client user “closes the project,” which initiates the further stages of the reverse-invoicing process. Phase III involves the possible revision of the invoice, e.g., due to changes which have occurred during the project, and submission of the possibly-revised invoice to the vendor user for a second, i.e., final, approval. Phase IV involves the entry of the invoice into the client user's payment queue after it has been approved by the vendor user. Each of these phases is discussed in further detail below in the context of representative screens presented by the electronic invoicing system to the client users and vendor users.

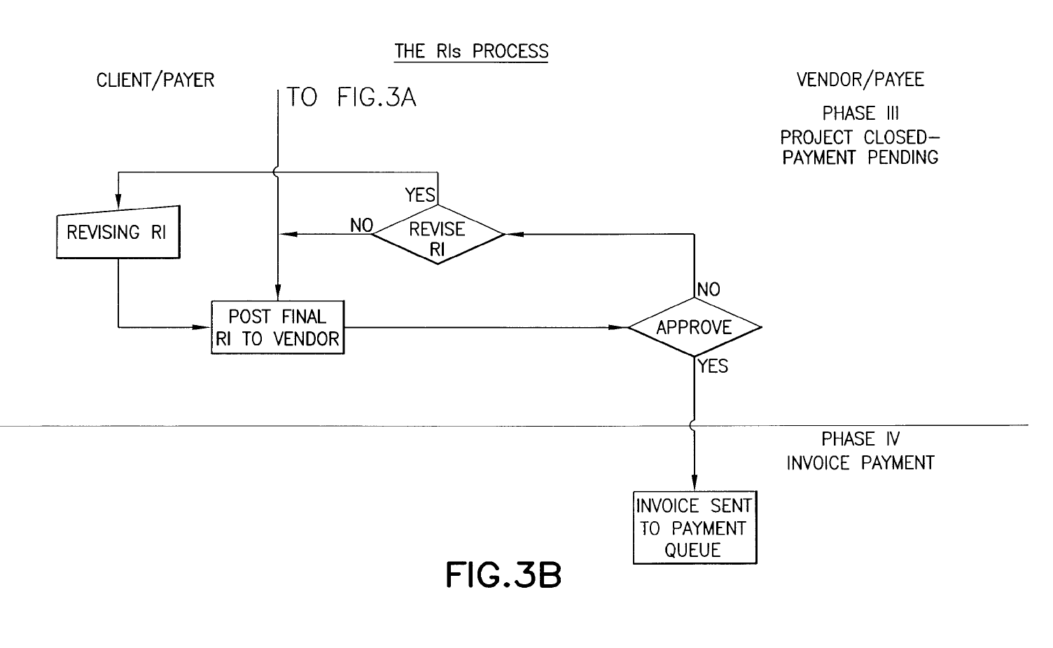

FIG. 4 depicts an account summary screen for the client user of the electronic invoicing system, which summarizes the status of the client user's invoices and presents an activity window showing invoice-correlated messages. On the summary page, one see the name of the client user, e.g., “Ed Smith,” at the top right and the indication that this is a client account summary. This may be the first page that the client user sees when they log on to the electronic invoicing system using their user name and password. This page is a summary of the invoices that have been sent to and from the client user and the status of those invoices. The business transaction network (BTN) activity window (alternatively, this may be called business transaction messaging (BTM) window) lets the client user know which messages he has waiting. The client user may click on those messages, or they may appear in the window already opened. All of the messages in the activity window concern particular invoices, i.e., each message must be correlated to a particular invoice. Each message is marked with a user name of the sending user and the invoice identifier, e.g., invoice number, of the invoice with which it is connected.

On the right-hand side of the account summary screen, there may be an open-invoice access window. This window lists all the invoices that are open, i.e., all invoices which are not yet closed. A color code may be used for the vendor user/invoice identifiers. For example, there may be red marks before the vendor user name and invoice number indicating that some action is needed by the client user, Ed Smith, such as an incoming message from a vendor user requiring an answer. Likewise, there may be green marks before the vendor user name and invoice number indicating that the project is in progress but does not require action at the present time. Clicking on these indicators may retrieve the relevant incoming message in the activity window.

In this example, in the open invoice access window, there are four different identifiers. The first and third identifiers, “ada#2123” and “dennisj#1120,” for example, may be marked with red, thereby indicating that these invoices require some sort of action by the client user. The other two, “markm#2142” and “ada#2145,” are marked in green, which indicates that no action is required at the present time. The identifiers are formed by a vendor user identifier, e.g., “ada,” and an invoice identifier, e.g., “2123.” There may also be a symbol dividing the vendor user identifier and the invoice identifier, such as, for example, a hash mark (“#”). The vendor user name and invoice identifier may be concatenated together to form a single identifier, i.e., an identifier implemented as a single data element. Alternatively, it is also possible to keep these identifiers as two separate fields. In other words, the identifiers can be combined or kept as two individual fields. Regardless, each identifier is required to have both a vendor user identifier and an invoice identifier.

Each message in the activity window also has an identifier similar to those displayed in the open-invoice access window. Each message must come from a particular user, e.g., a vendor user, and each message has to be correlated with a particular invoice, i.e., “project,” which is the invoice identifier portion of the message identifier. The two identifiers, as noted above, may be handled separately in the system database. In other words, the vendor user identifier and the invoice identifier for a particular message may be displayed together in a concatenated form, but it is not necessary for this message identifier to be one single piece of data, i.e., data element. Rather, the message identifier, as discussed above, could be two separate data elements.

It is apparent that there is a substantial difference between an invoice-correlated message and a conventional message between two people, e.g., a text or chat message, in that a conventional message between two users would have just a user name (i.e., of the sending user) and message could be about anything, which results in a disorganized form of communication. Even a supposedly categorized message, such as an email with a subject line, is susceptible to getting separated and/or lost in the recipient's inbox from other messages pertaining to the same subject. This is because users may not be diligent about consistently using precise subject lines, which might allow for correlation of related messages. By contrast, the disclosed embodiments require each message to have both a user name (e.g., the sending user) and an invoice identifier. Furthermore, in many conventional messaging systems, the project manager or the person the client user has been dealing with for a particular project may get lost. This commonly results in messages being sent to the wrong person. The disclosed embodiments avoid such problems by requiring both a sending user identifier and an invoice identifier for each message identifier.

Messages may be sent automatically within the system in response to certain events, such as, for example, the creation and posting of a new invoice to a vendor. Messages, whether created by a user or automatically generated, are sent to a portal of the recipient user, which may be, for example, a webpage, if the user is logged in to the system on a computer, or an application (i.e., an “app”) running on a mobile device. For example, a vendor user may receive a message on their mobile device when a new invoice is posted to their account by client user Ed Smith: “EDS#2142 New Project.” The app running on the mobile device may be set up to provide an indicator to the user when a message is received, e.g., a badge or an alert. The recipient user, e.g., a vendor user, can then click on an app icon to start the app on their device. The app displays a listing of received messages. If the message received relates, for example, to a newly-created invoice, then the recipient user can click on the message to view the invoice document. The invoice document may be retrieved, e.g., via the user's browser, and displayed on the device. The vendor user can then click on an “Accept” button or a “Contest” (or “Vendor Exception”) button, as in the web browser-based version of the portal. Alternatively, the message may be sent in the form of an email in which the subject line (or other available field, e.g., a portion of the message body) is constrained to the invoice-correlated identifiers by the app used to create (and read or reply to) the email.

The bottom portion of the account summary page summarizes information relating to the client user's invoices, such as, for example, all of the invoices cumulatively that have been paid to date, the number of invoices that have been opened and closed in the queue, the amount of total payments which have been made to date. On the bottom right-hand side of the summary screen there may be a summary of Action Items requiring the attention of the client user. For example, the screen of FIG. 4 shows that there are 8 invoices in the payment queue and a cumulative total of 53 reverse invoices (RI) have been paid. In the Action Items, there are no draft RIs and two RIs awaiting vendor approval. There are five projects in progress and one vendor exception awaiting a response (i.e., a vendor user has contested one invoice).

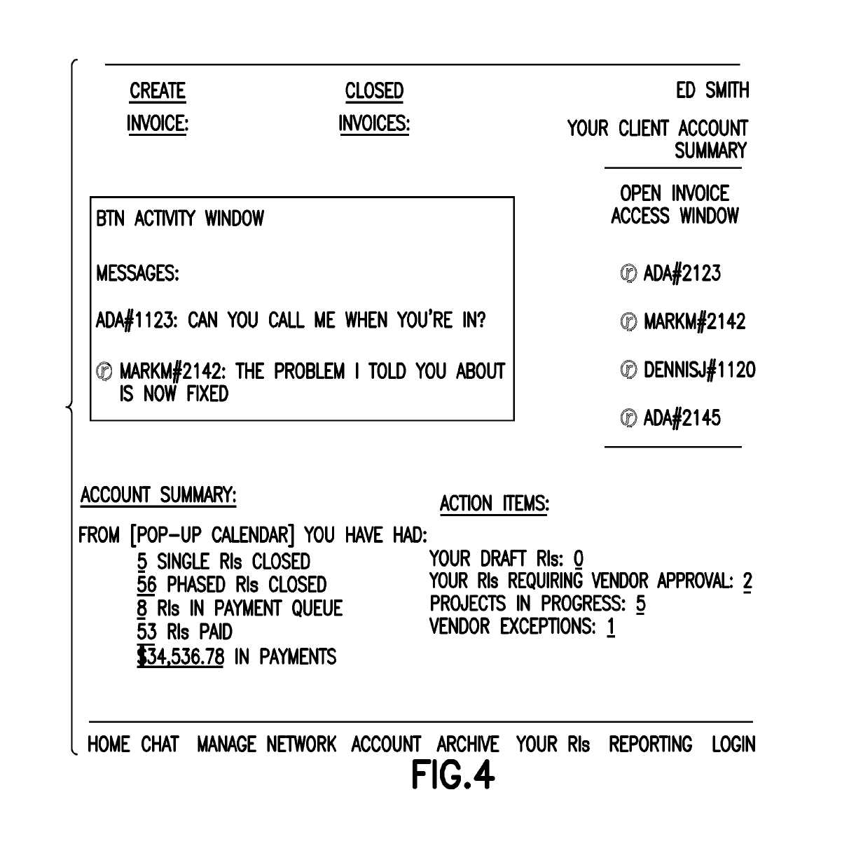

If the client user clicks on the “Create Invoice” link on the top left portion of the summary page, then that takes the user to the Create Invoice page, as discussed below with respect to FIG. 5.

FIG. 5 depicts an invoice creation screen which allows the client user to input invoice data to generate an invoice document. The invoice creation screen includes various entry boxes and/or menus which allow the client user to fill in the necessary information to create an invoice. The “Payer” is typically the client user. However, the client user may be managing projects for different companies, so there may be a need to enter different payers or select them from a menu. There is also a vendor field, which provides for a choice of vendor users to whom to direct the invoice. In certain situations, as discussed below, an invoice may be directed to more than one vendor. In such a case, the client user may be able to select multiple vendors from a menu. Certain fields, such as the reverse invoice (RI) date field may be populated with information, e.g., the current date, but may be edited by the client user. Certain fields, such as the invoice number (i.e., invoice identifier, which need not be strictly numeric), may be populated automatically and may or may not allow editing, depending upon the circumstances and/or preset preferences.

The client user enters the quantity of services (e.g., number of hours) and/or goods (e.g., numeric quantity of goods) and the rate (e.g., cost per hour or unit cost of goods). The amount is calculated from these values, or the amount may be entered directly without filling in the quantity and rate fields. The system automatically calculates the relevant tax (e.g., based on a selected location) and total. The client user may also enter a description. The terms, i.e., payment terms, may be filled in automatically depending upon the particular selected vendor based on pre-stored information. For example, there may be a capability to enter and store a vendor profile for each vendor user with whom the client user deals, and the terms negotiated with each vendor may be filled in automatically when the vendor is selected.

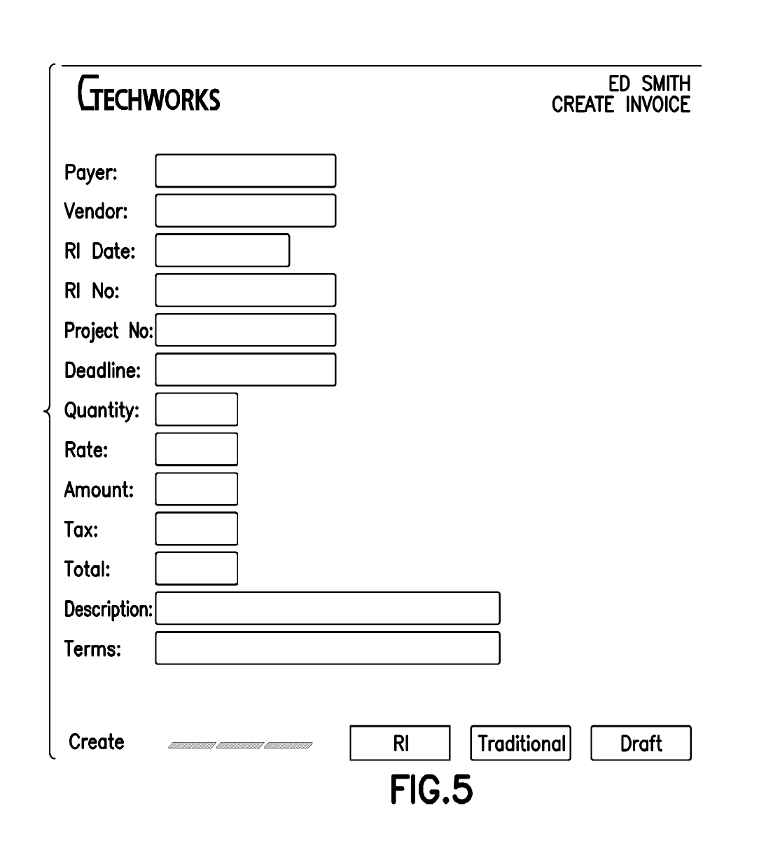

FIG. 6 depicts a generated invoice document in Phase I of the reverse-invoicing process based on the invoice data input by the client user. The invoice document has the appearance of a traditional invoice and may be printed or exported in various electronic forms, e.g., as a word processing file or portable document format (PDF) file. The invoice document includes fields in which the information entered by the client user in the Invoice Creation screen are presented. The invoice document also includes such information as: the client user's name and address, the vendor user's name and address, the date of the invoice, the invoice identifier, and the payment terms. Every time an invoice is created there is a record and an image kept of that invoice. So, if the client user wishes, they can go to the top of the page at any time and click on “versions,” which is next to the invoice identifier in this example, and it takes the client user to the “time capsule” page where all of the various iterations of the invoice generated with that particular invoice identifier are available.

One or more actuators, e.g., clickable buttons, are provided at the bottom of the page to allow the client user to post the invoice to a vendor user or to multiple vendor users (i.e., “Post to Network). The Post to Network actuator may be provided as an alternative to, or in addition to, the ability to select multiple vendor users in the Invoice Creation screen.

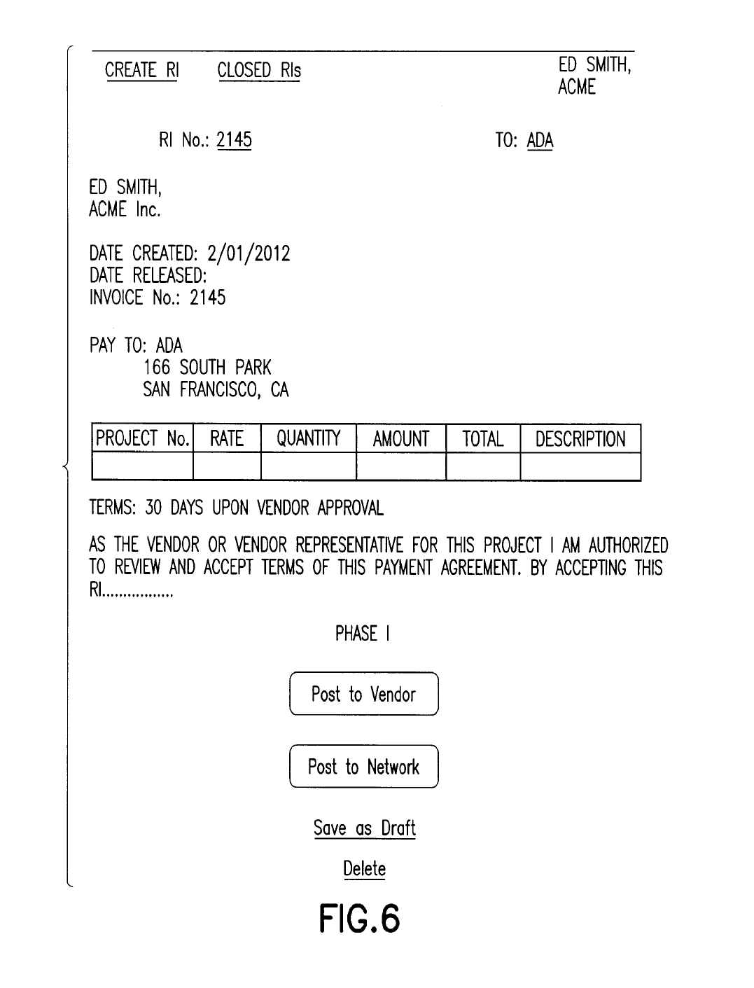

FIG. 7 depicts an invoice document in Phase I of the reverse-invoicing process after the client user has posted the invoice to the vendor user. The client user is presented with the invoice document which includes the image of the invoice document which was created, along with a message at the bottom of the page which states “Phase I: Vendor Approval Pending.” This indicates to the client user that he is awaiting approval of the invoice by the vendor user to whom it was posted.

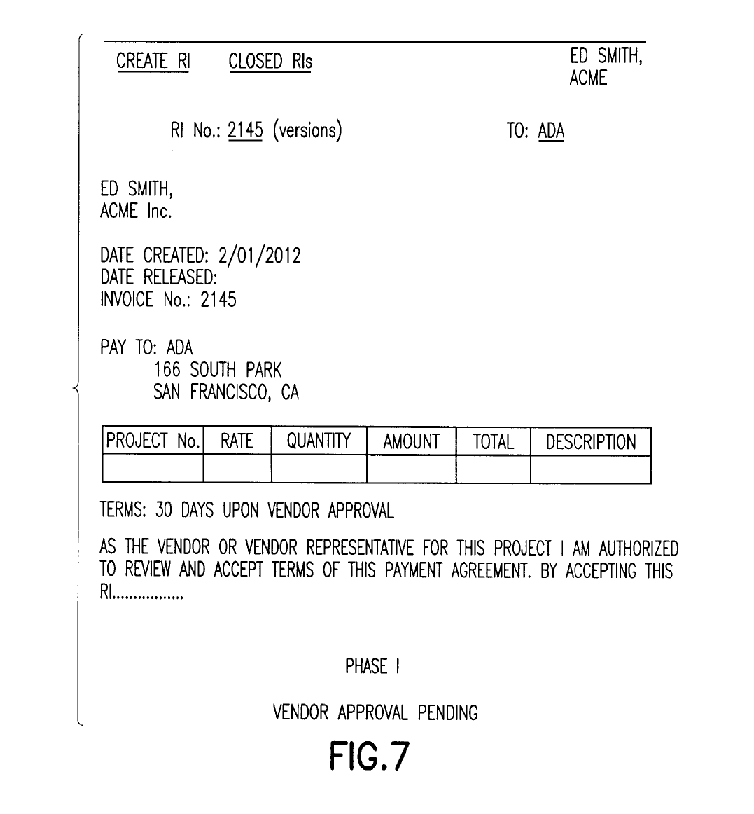

FIG. 8 depicts an account summary screen for the vendor user of the electronic invoicing system, which summarizes the status of the vendor user's invoices and presents an activity window showing invoice-correlated messages. This screen is similar to the client user account summary discussed above (see FIG. 4), but the invoice information is presented from the vendor user's perspective. In other words, it displays all of the invoices currently pending for projects being handled by that particular vendor user, e.g., “Ada”. For example, the screen indicates that there is currently one reverse invoice (RI) awaiting approval by the vendor user.

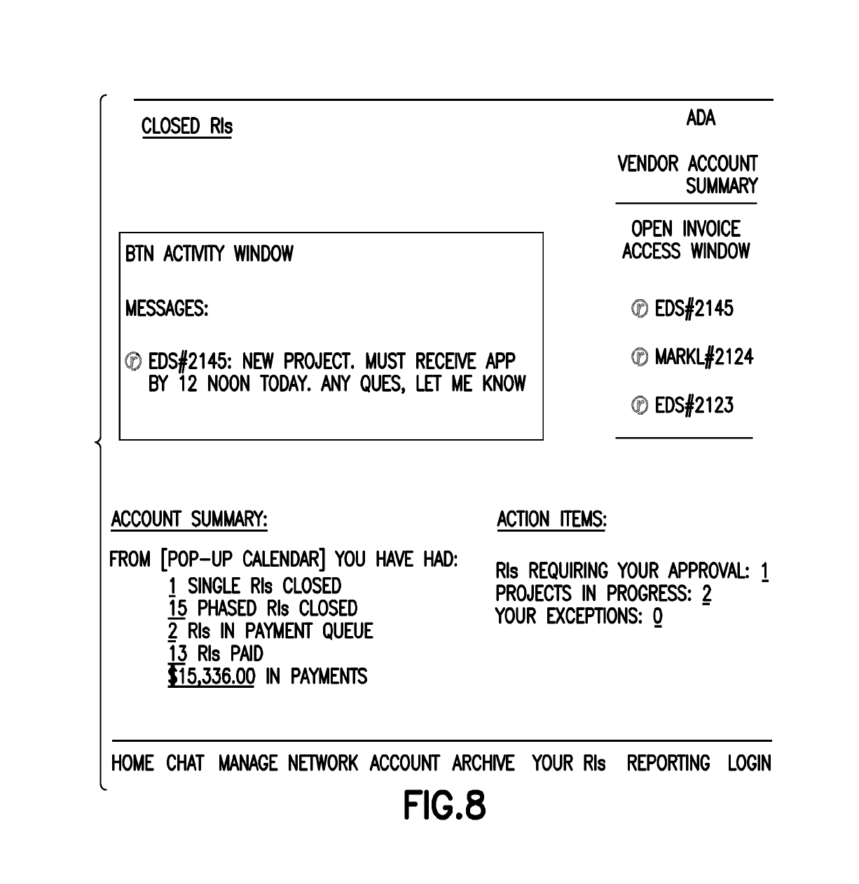

FIG. 9 depicts an invoice document in Phase I of the reverse-invoicing process as it appears to the vendor user for approval after the client user has posted the invoice to the vendor user. As discussed above with respect to FIG. 7, an invoice (i.e., RI no. 2145) was posted to vendor user Ada by client user Ed Smith. This invoice document is now presented to Ada along with two actuators, e.g., clickable buttons, at the bottom of the page: “Approve” or “Vendor Exception”. If the vendor user is satisfied with the invoice which has been created and sent to him by the client user, Ed Smith, then he clicks on the APPROVE button. Otherwise, if the vendor user wishes to contest the invoice, e.g., if he believes there is an error in the invoice, he clicks on the VENDOR EXCEPTION button. Of course, the vendor user may also decide to take no action at the current time and may return to the screen later. For example, the vendor user may decide to send a message to the client user asking a question before deciding whether to accept the invoice.

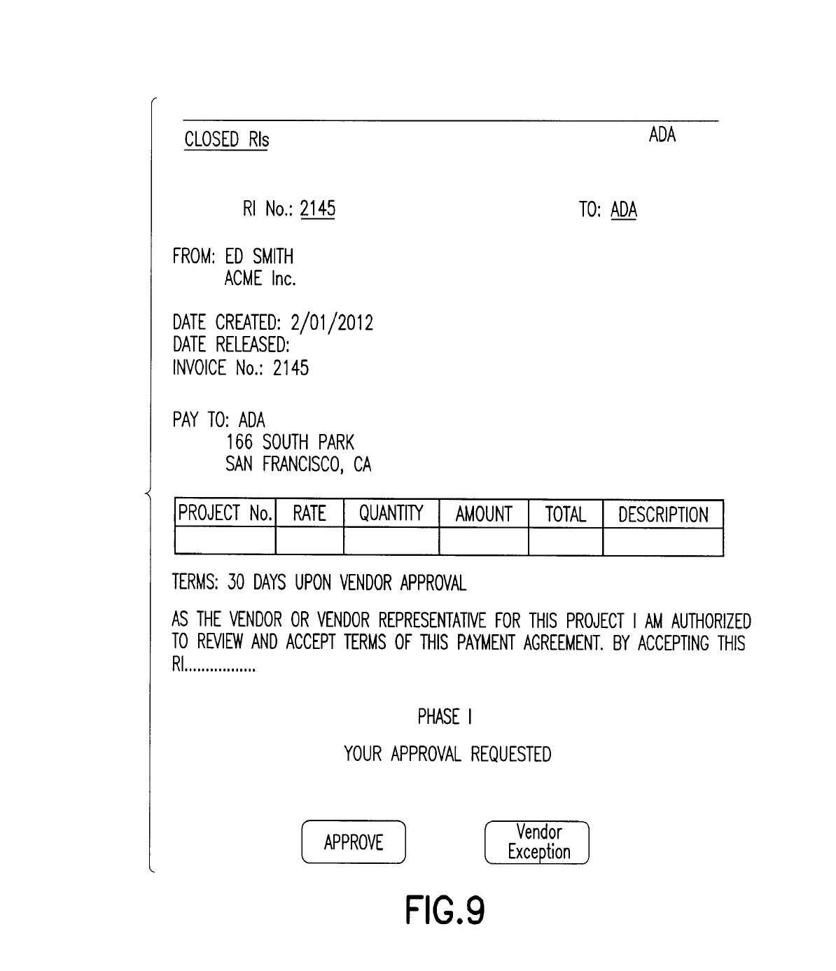

FIG. 10 depicts an invoice document in Phase II of the reverse-invoicing process as it appears to the vendor user after the vendor user has approved the invoice in Phase I. This screen is presented to the vendor user to confirm that the invoice has been approved. The screen includes the invoice document and a message at the bottom: “Phase II: Approval Sent, Project in Progress.” This indicator means that the vendor user now undertakes to perform the necessary services and/or produce the necessary goods required under the project to which the invoice corresponds.

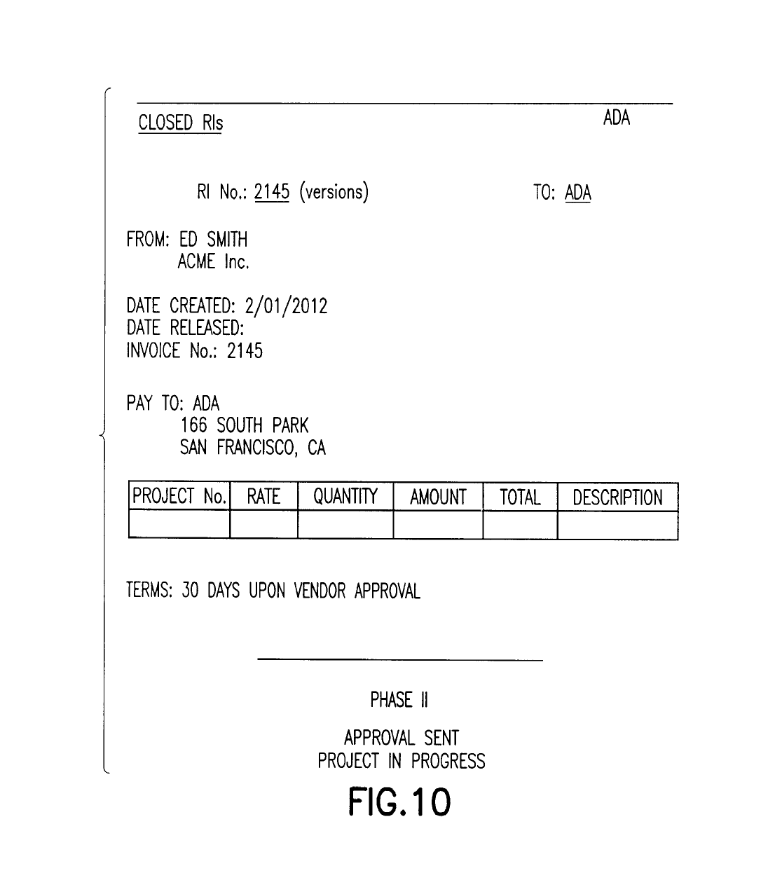

FIG. 11 depicts an invoice document in Phase II of the reverse-invoicing process as it appears to the client user for closing of the project after the vendor user has approved the invoice in Phase I. The invoice document is presented to the client user to inform the client user that the invoice has been approved by the vendor user and that the project has commenced. The screen includes the invoice document and the message: “Phase II: Approval Received, Project in Progress.” The screen also includes two actuators: “Close Project—Post to Vendor” and “Revise.” The screen remains in this state until the client user has received the goods and/or services and is satisfied with them. At such time, the client user clicks the “Close Project” button.

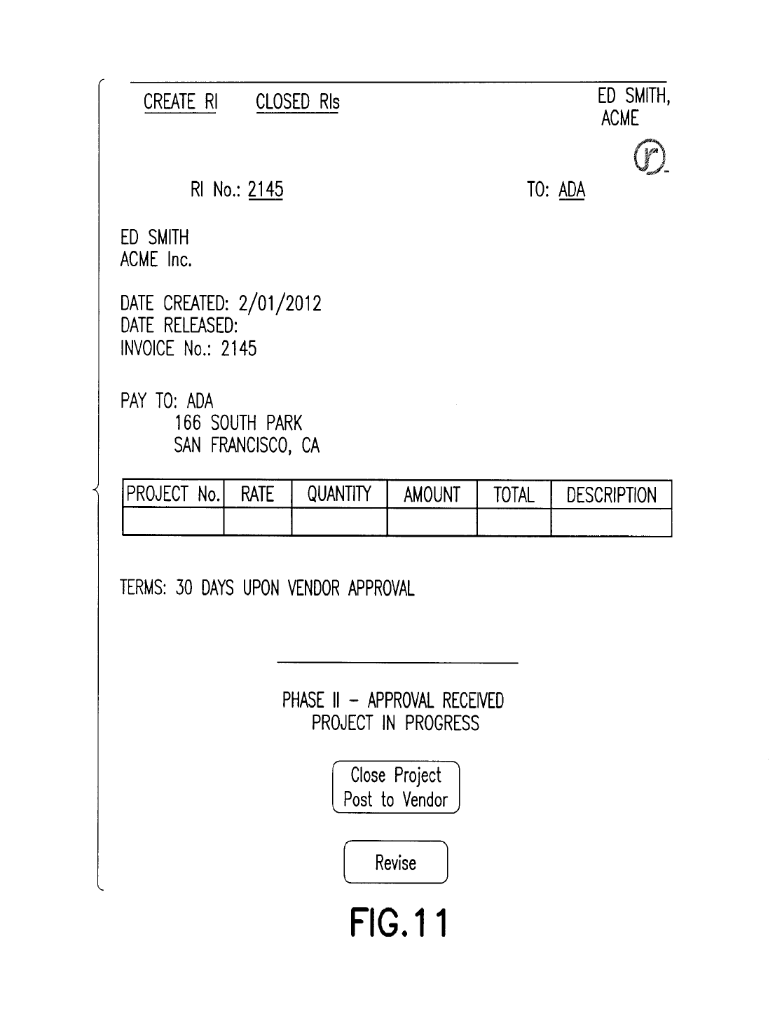

FIG. 12 depicts an invoice document in Phase III of the reverse-invoicing process as it appears to the client user after the client user has closed the project corresponding to the invoice in Phase II. This screen is presented to the client user in order to confirm that the project is closed. The screen includes the message: “Phase III: Vendor Approval Pending.”

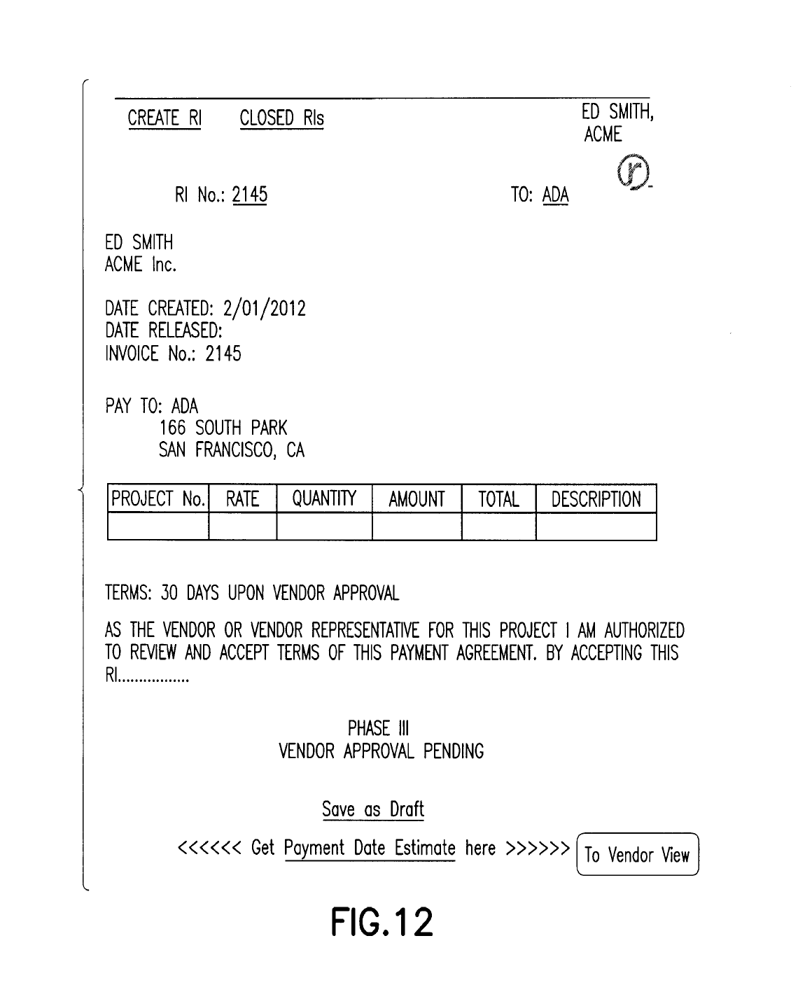

FIG. 13 depicts an invoice document in Phase III of the reverse-invoicing process as it appears to the vendor user for approval after the client user has closed the project corresponding to the invoice in Phase II. This screen is presented to the vendor user to inform the vendor user that his final approval (i.e., typically second approval) is awaited. Assuming that nothing has occurred during the course of the project to change the terms of the initial invoice, then the vendor user clicks the APPROVE button. Alternatively, the vendor user may contest the invoice by clicking on the VENDOR EXCEPTION button, as discussed above with respect to FIG. 9.

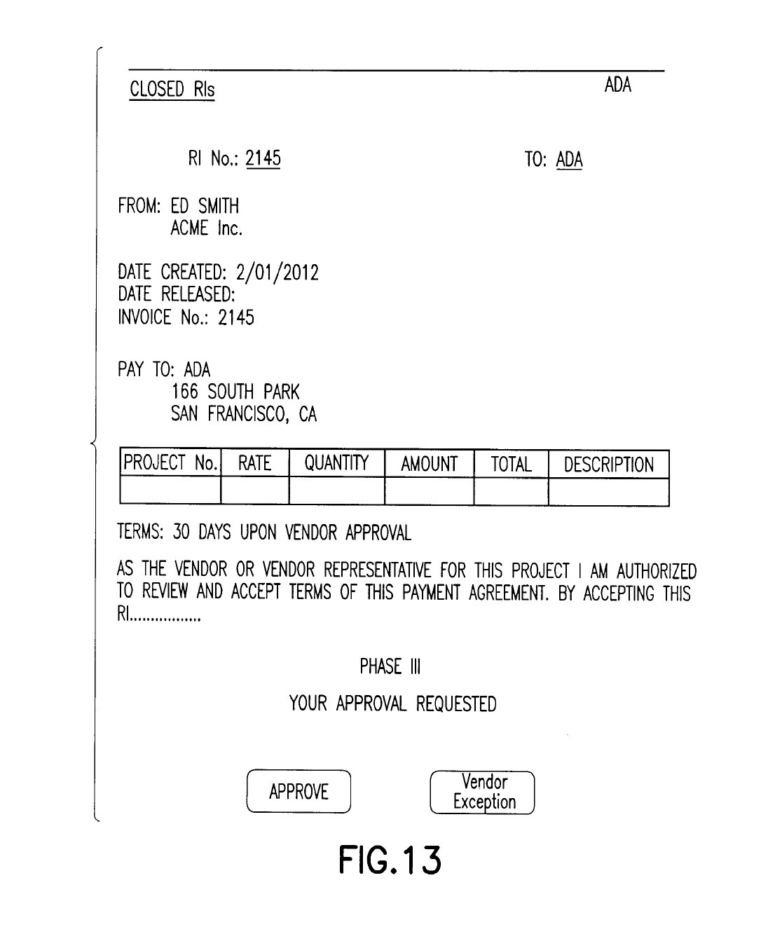

FIG. 14 depicts an invoice document in Phase IV of the reverse-invoicing process as it appears to the vendor user after the vendor user has approved the invoice in Phase III. This screen is presented to the vendor user to confirm that the invoice has been approved. The screen includes the message: “Phase IV: Your Approval Sent, RI in Payment Queue.”

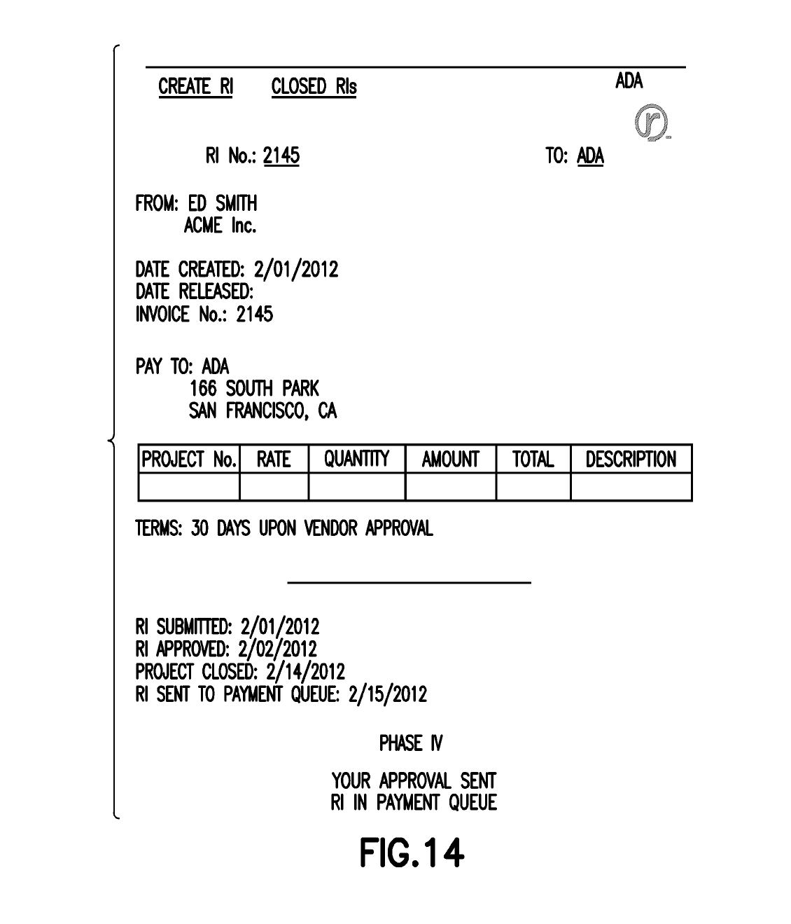

FIG. 15 depicts an invoice document in Phase IV of the reverse-invoicing process as it appears to the client user after the vendor user has approved the invoice in Phase III and the invoice has entered the payment queue. This screen is presented to the client user to inform the client user that the vendor user has approved the final invoice, i.e., the invoice as it stands after the closing of the project. The screen includes the message: “Phase IV: Vendor Approved, RI Sent to Payment Queue.” The screen may also include such information as the date the RI was submitted and approved, the date the project was closed, and the date the RI was sent to the payment queue.

The following discussion relates to aspects of the electronic invoicing process in which the vendor contests, i.e., initiates a “vendor exception,” to an invoice. This portion of the process begins at the after the invoice has first been submitted to the vendor in Phase I, as discussed above with respect to FIG. 7. The vendor exception process may also occur after the project is completed and the final invoice is sent to the vendor user for approval in Phase III, as discussed above with respect to FIG. 12. Because the vendor exception process in Phases I and III is similar, only the Phase I vendor exception is discussed below.

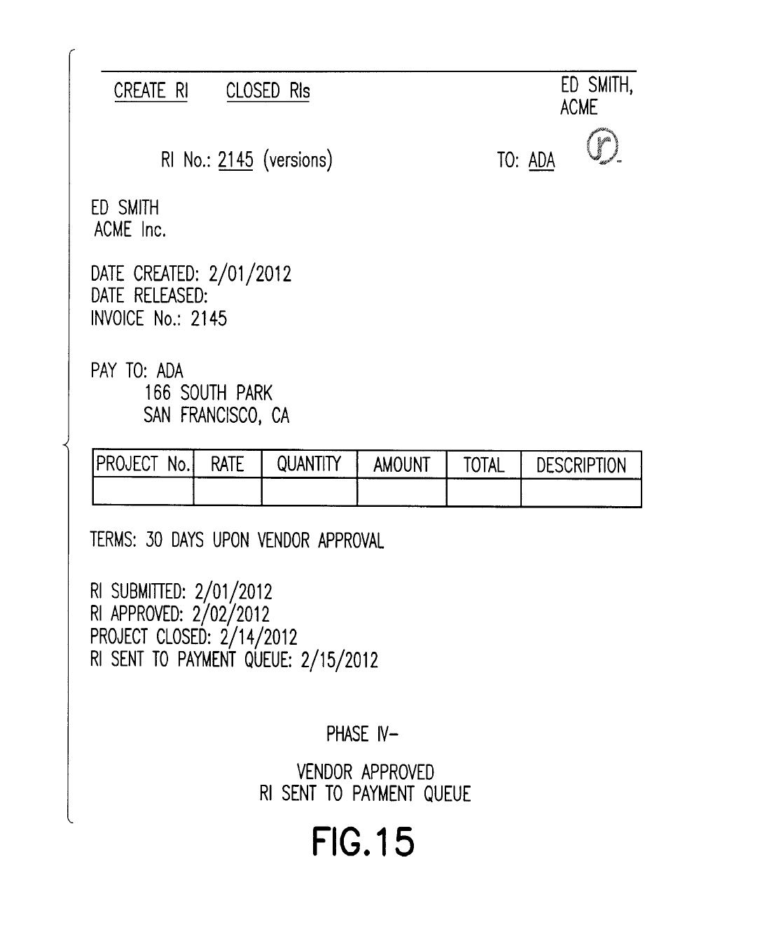

FIG. 16 depicts an invoice document in Phase I of the reverse-invoicing process as it appears to the vendor user after the vendor user has indicated that the invoice is to be contested. This screen presented to the vendor user after the vendor user has clicked on the “Vendor Exception” button. The screen includes the invoice document and a box to enter comments to explain the to the client user why the invoice is being contested.

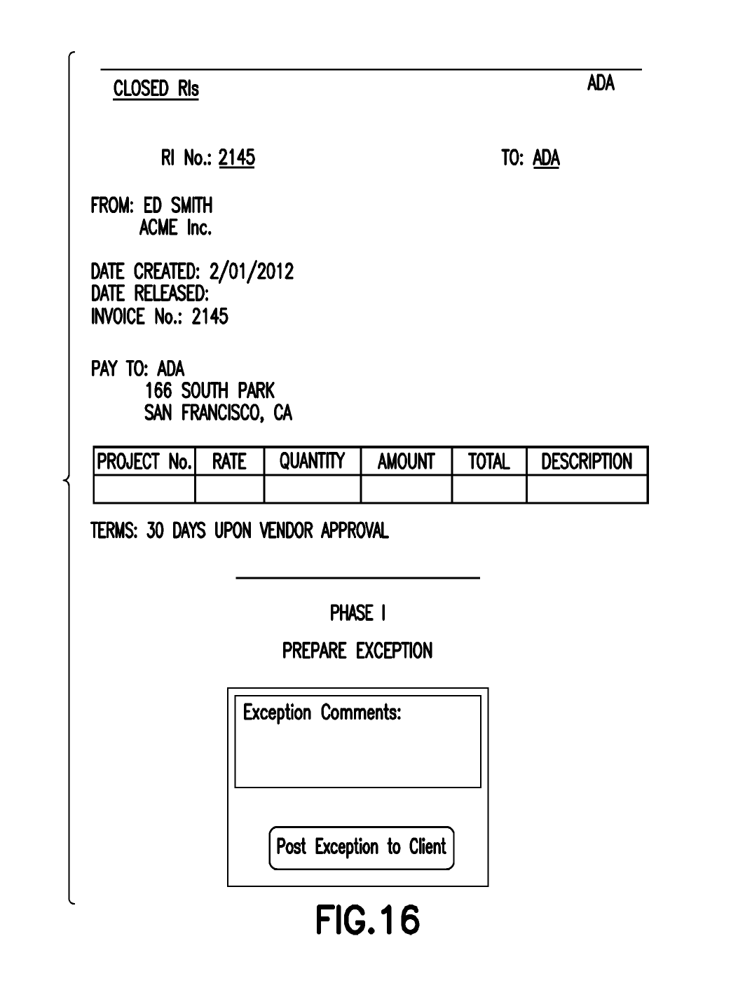

FIG. 17 depicts an invoice document in Phase I of the reverse-invoicing process as it appears to the vendor user after the vendor user has posted the contested invoice back to the client user. This screen is presented to the vendor user to confirm that the invoice has been sent back to the client user marked with an exception (i.e., the invoice has been contested). The screen includes a message stating: “Phase I: Your Exception Has Been Sent.” There is also an actuator, e.g., a button or link, which allows the vendor to review and/or edit the comments he has submitted with the vendor exception.

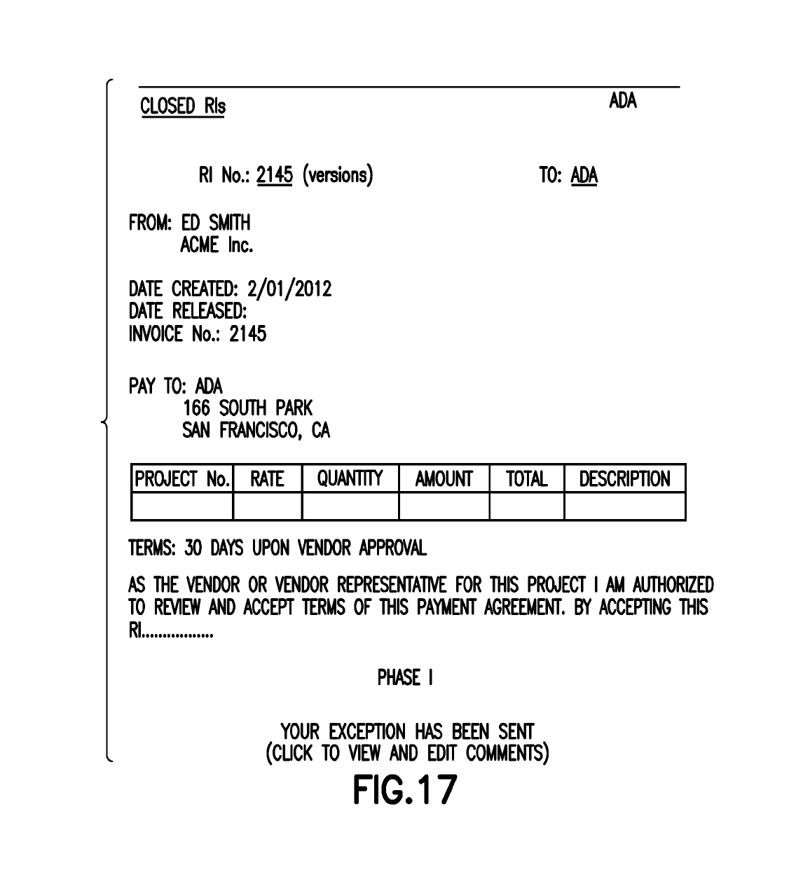

FIG. 18 depicts an invoice document in Phase I of the reverse-invoicing process as it appears to the client user after the vendor user has posted the contested invoice back to the client user. This screen is presented to the client user to inform the client user that the vendor user is contesting the invoice. The screen includes a message stating: “Phase I: Vendor Exception.” The screen also includes an actuator to allow the client user to view the comments entered by the vendor user in contesting the invoice. Alternatively, the comments, or a portion thereof, may be initially displayed on the screen without requiring action by the client user. There is also an actuator to allow the client user to revise the invoice.

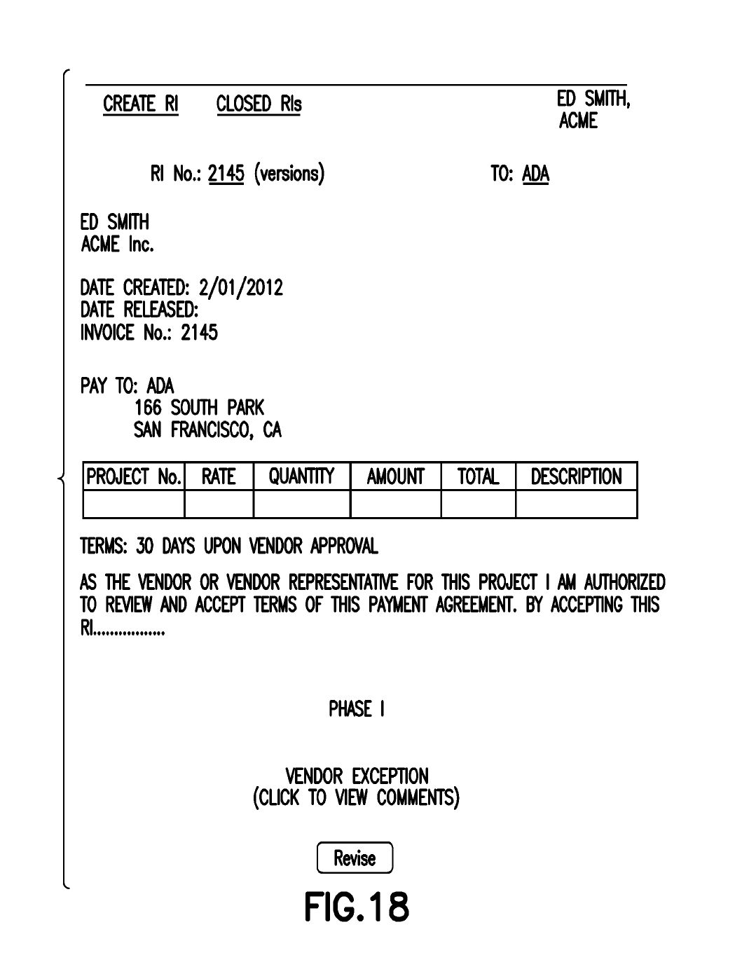

FIG. 19 depicts an invoice document in Phase I of the reverse-invoicing process as it appears to the client user as it is being revised after the vendor user has posted the contested invoice back to the client user. The screen is presented to the client user to allow revisions to be made to the invoice. The invoice document is presented, as in other screens, however the fields of the invoice, such as, for example, the amount and quantity fields, can be edited by the client user. When the revisions are completed, the client user clicks on the “Post Revision” button to post the revised invoice to the vendor user.

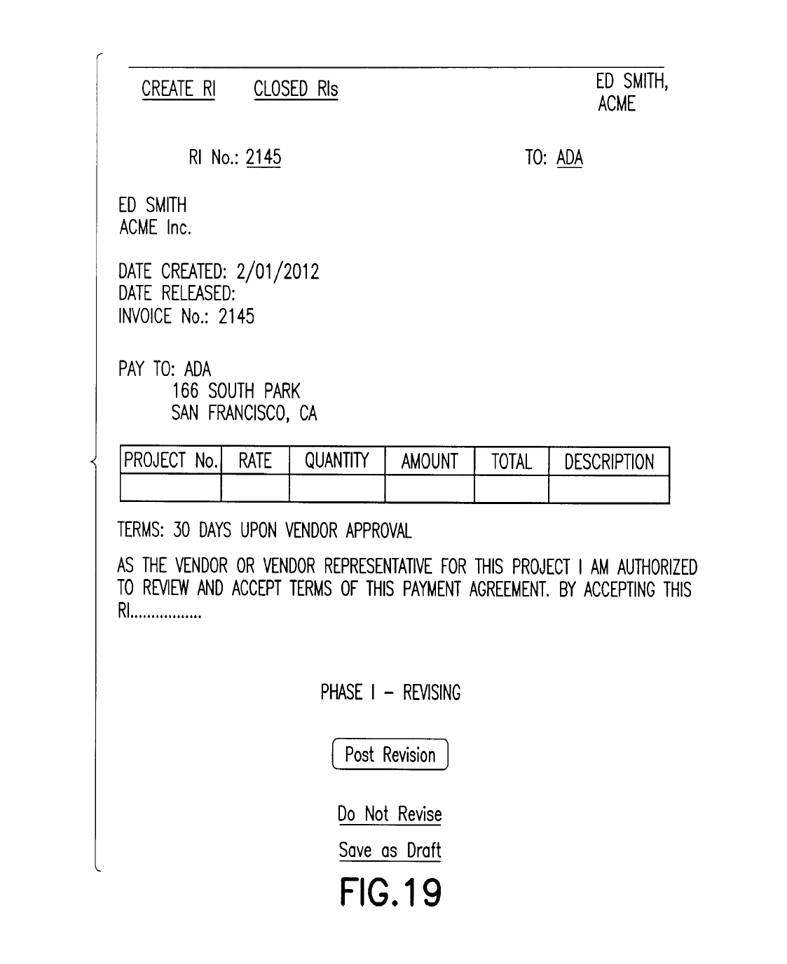

FIG. 20 depicts an invoice document in Phase I of the reverse-invoicing process as it appears to the client user after the revised invoice has been posted to the vendor user. This screen is presented to the client user to confirm the revisions to the invoice and to indicate that vendor approval is awaited. A message at the bottom of the screen states: “Phase I: Revised RI Issued (1), Vendor Approval Pending.” It should be noted that the invoice identifier of the revised invoice has been changed to “2145-1” in order to alert the client user and vendor user that this is a different version of the invoice. The revised invoice document is then presented to the vendor user for approval. This process is similar to the process described above for the original invoice, as discussed with respect to FIGS. 9 and 10.

The following discussion relates to screens which are used to initiate an analysis of reverse invoice in order to determine when these invoices are likely to enter the payment queue, i.e., after approval by the vendor user, and then, based on the particular payment terms, when a payment is due. This analysis can help the client user more accurately manage and control their cash flow. The screens are discussed in the following paragraphs, followed by a more detailed discussion of the prediction analysis.

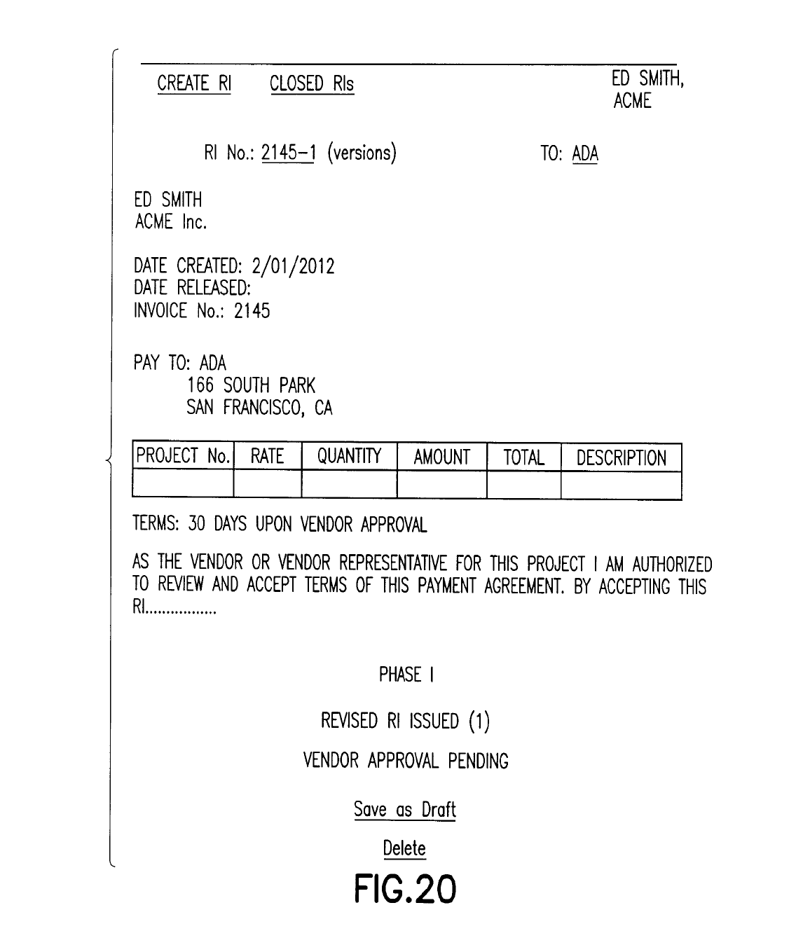

FIG. 21 depicts a menu allowing selection of query types for an Accounts Payable report and payment predictions for reverse invoices. This screen may be accessed from various screens in the electronic invoicing process, such as, for example the screen confirming Phase III vendor approval (see FIG. 12). This screen allows selection of an Accounts Payable report or a Payment Prediction report.

Predictions of payment dates depend upon how long the vendor user takes to approve the invoice following completion of the project. The approval date, in conjunction with the payment terms, determines the payment due date for the client user. The number of days the vendor user takes to approve the invoice after the project is closed can be predicted based on past invoice approval data. These predictions are available to the client user at any time after the initial invoice is approved, i.e., once the project is in progress. This allows the client user to determine the most opportune time to close the project, which is an action which is under the control of the client user and therefore completely known. Closing the project starts the waiting period for vendor approval of the final invoice, which is a time period which is not known to the client user, but which can be estimated. This estimated period can then be added to the payment terms, which define a period within which the invoice must be paid, to determine an estimated payment due date.

In other words, the client user can close the project today, or they can close it next week, which sends it to the vendor for final approval. Once the client clicks on close project button, the timing of the payment due date is out of their hands. It is in the hands of the vendor to decide when to click the “Approval” button and send the invoice into the payment queue. Therefore, it would be advantageous for the client user to know whether it is a good time to send the invoice to the vendor (i.e., close the project), and eventually have it put into the payment queue, considering the client user's cash flow situation. This determination requires an estimate of how long it might take the vendor user to approve the invoice and put it in the payment queue, at which point it is subject to the agreed-upon payment terms.

The electronic invoicing system provides for two types of query/report types. One type is an Accounts Payable report, which presents a list, in a form similar to a spreadsheet, of all of the client user's accounts payable. The other type is a Payment Predictions report, in which the system generates a series of payment dates which are predictions of when the money is going to actually come out of the client user's account. These predictions are based on several different factors, such as, for example, the profile of vendor user, e.g., their invoice approval history, and the profile of the project, e.g., the size of the project, etc. All of this is factored into a prediction of days to payment due date for each individual invoice.

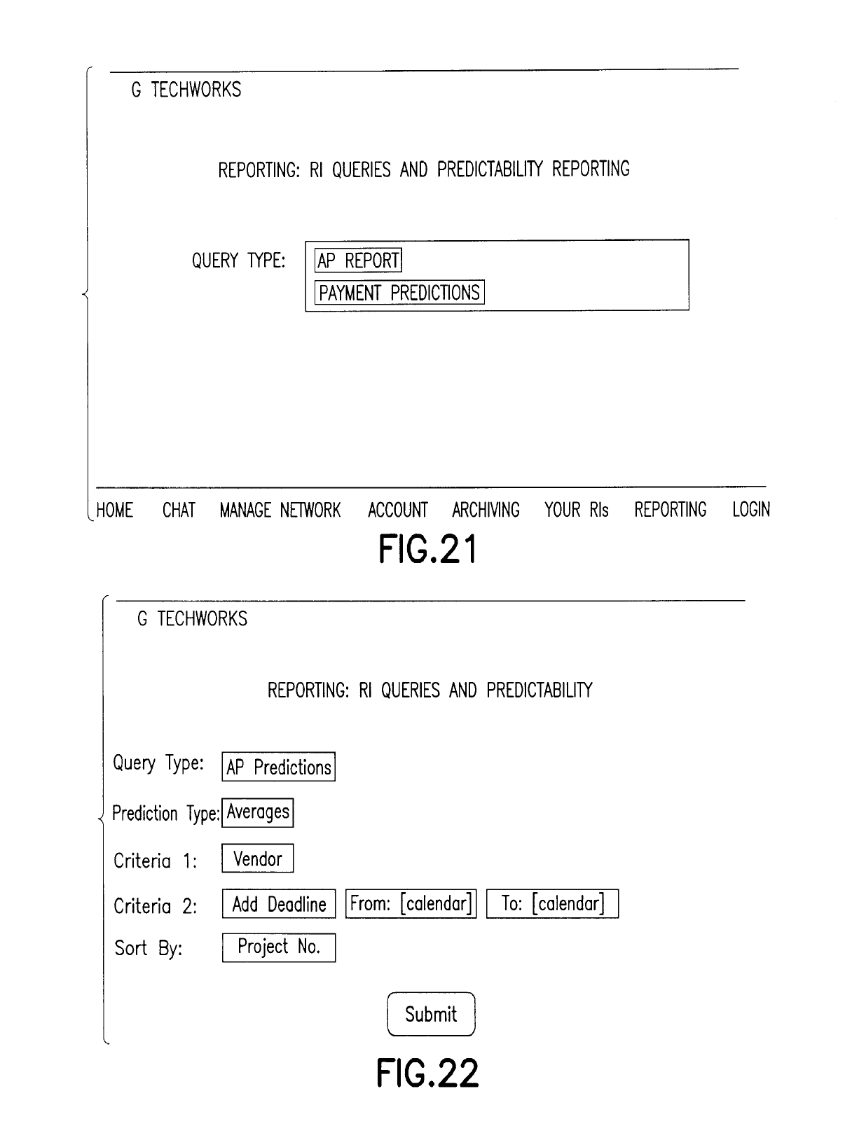

FIG. 22 depicts a query parameter entry screen for Accounts Payable predictions for reverse invoices. Various parameters may be entered to customize the report. For example, a prediction type can be selected, e.g., averaging or probability-based, as described in further detail below. Also a particular vendor user and/or project may be selected and particular dates or date ranges may be selected for analysis.

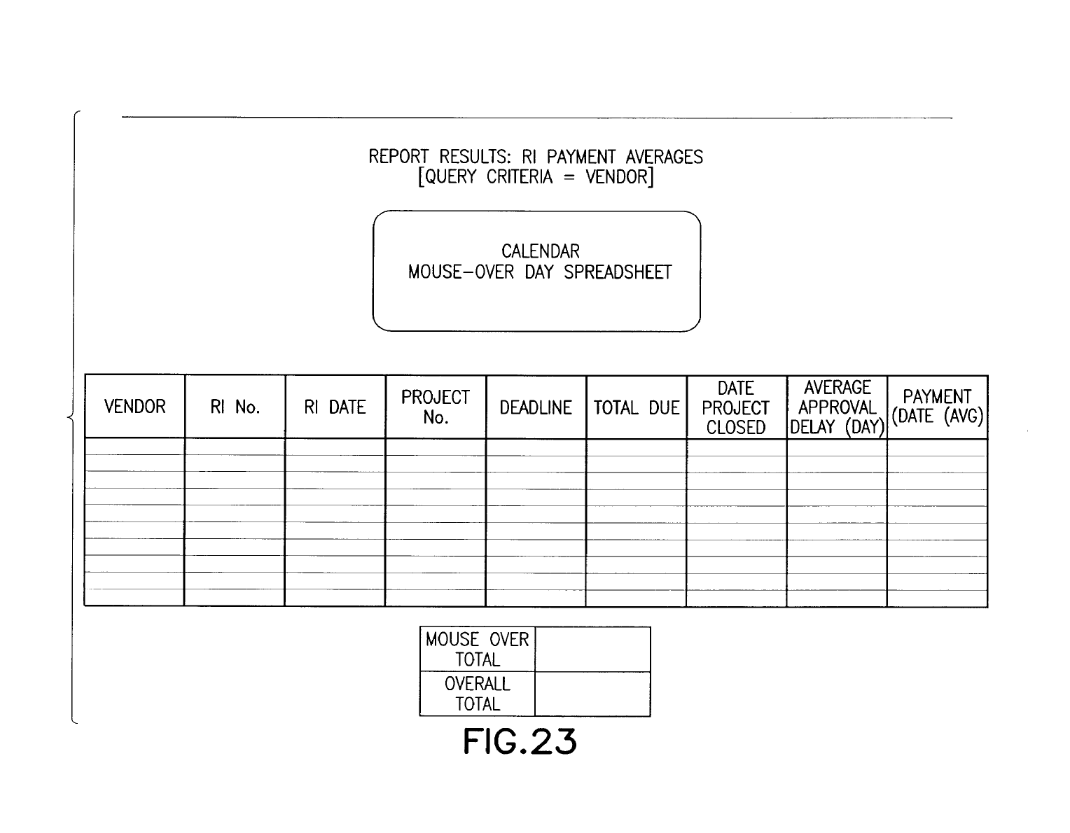

FIG. 23 depicts an Accounts Payable prediction report for reverse invoices. This report presents the vendor users' names and corresponding invoice identifiers, date of the invoice, project number (if there is a separate project number), the total amount due, the date closed, average approval delay, and then the payment due date, which is determined based on the payment terms in conjunction with the estimated/predicted vendor approval delay.

This information may be presented in the form of a spreadsheet, as shown in FIG. 23. The results screen may also include a calendar at the top portion of the page which allows the client user to move the interface device, e.g., a mouse, over particular dates on the calendar to display payment due information for that day. The spreadsheet has all of the information from the prediction, i.e., the raw results from the query, and below the spreadsheet is a total of the amount which must be paid for the period. This allows the client user to get an idea of the overall total accounts payable for a period of time or to get the daily amount that is going to be paid out by “mousing,” i.e., wanding, over any other days on the calendar. This is helpful to the client users because they usually known when they are going to get paid and how much money will be going out on any given day. This, in turn, allows the client user to determine whether there will be enough money available to meet the payment amounts due each day. This Accounts Payable information can be integrated with Accounts Receivable from an accounting system in order to calculate actual cash flow.

The following is a more detailed discussion of the Accounts Payable estimation techniques.

In the “Invoice Analysis” or query page of RIS (see FIG. 22), client users can choose whether to perform an averaging-based analysis or a probability-based (i.e., statistical) analysis of submitted invoices. If the client user chooses average analysis, RIS then prompts the client user to select: a) the vendor user(s) whose invoice choices should be analyzed; and b) the time period or calendar day for the analysis. These selections define the variables RIS uses in the analysis query. When the client user requesting the analysis chooses to analyze the invoices of a vendor user or vendor users, the resulting report provides: 1) the average number of days between submission of an invoice and vendor user and when the vendor user clicks ACCEPT; and 2) the payment date for each outstanding invoice for the chosen vendor user; and 3) a prediction of the actual amount due the chosen vendor user on the day or period selected.

Result (1) is dependent on the historical data in the database. Result (2) is dependent on result (1) and result (3) is dependent on (2). For example, if a client user wishes to perform an average analysis of the invoice choices of vendor user “Ron,” as of the current day, Oct. 21, 2011, for payment of outstanding invoices on November 4, they access the average analysis query page and set these query parameters. There is a 10-day Payment Term to Ron that begins from the time his invoices enter the payment queue. Historical choices made by Ron, stored in a database tables indicate that Ron's choices prior to October 21 would be the following:

| | Submit | Choice | | Time | |
|---|---|---|---|---|---|
| Invoice # | Date | Date | Choice | Interval | Amount |
| 2388 | May 13, 2011 | May 14, 2011 | ACCEPT | 1 | $250.00 |
| 2430 | Jun. 20, 2011 | Jun. 22, 2011 | CONTEST | 2 | $485.35 |
| 2430 | Jun. 20, 2011 | Jun. 27, 2011 | ACCEPT | 7 | $500.35 |
| 2651 | Oct. 3, 2011 | Jul. 15, 2011 | CONTEST | 12 | $330.00 |
| 2651 | Oct. 3, 2011 | Oct. 20, 2011 | ACCEPT | 17 | $330.00 |
| 2690 | — | — | — | — | — |

Result (1): 8.67 days. This means that given the conditions of this query, Ron accepts invoices that go into the payment queue, 8.66 days on average from the time he received the invoice from the client user. Result (2): November 8. This result takes into consideration the 10-day contractual payment term for payments to Ron. Therefore, the payment should be made to Ron 18.66 days after accepting. Result (3): $0.00. Since the next payment to Ron is due November 8, there is a $0.00 payment to Ron due November 4. Note that although invoice 2690 was generated because a project began that involves Ron, it has not closed and that invoice has not been submitted. Therefore, there is no RIS payment tracking for that invoice.

To perform the above analysis, RIS accesses the database for vendor users' actual historical responses to invoices they have received. RIS also accesses those invoices submitted to the vendor users and not the invoices generated for projects that have not closed. If the client user chooses to perform an average analysis of all outstanding invoices submitted RIS accesses the database and invoices for data collected for all vendor users. This reporting includes the same three result types—average days to accept, payment date for each invoice, and amount.

In addition to averages, RIS uses regression analysis and various statistical and probability-based algorithms to run analyses of vendor choices and payment data that enables the client user to generate predictions with greater predictability. In this analysis, predictions of the time that passes between the submission of an invoice to a vendor user and the moment they accept an invoice, the probability analysis is expressed in terms of probabilities. The coefficient is a numerical value between 0 and 1 that represents the likelihood a vendor user will accept an invoice when submitted to them. A value of “0” indicates a 0% chance the vendor will accept an invoice when first submitted by a client user. Conversely, a “1” indicates a 100% chance of acceptance when an invoice is first submitted. RIS generates a coefficient for each vendor user daily without any necessary action taken by a user. The coefficient is then used by the RIS analysis engine to plot probabilities of future vendor user response choices, and Accounts Payable events.

Many different known techniques for estimating the future based on the past behavior can be used here. Regression analyses and regression algorithms are examples of the types of formulas and methods which are used to generate probability reports. These types of analyses consider and integrate past choices and results in its calculation. They are also capable of including dynamic overlapping and changing relationships between the choice variables (i.e., ACCEPT, CONTEST, NO ACTION). An example of a dynamic overlapping relationship would be the relationship between the CONTEST and ACCEPT choices. Contesting one invoice influences the vendor user's next invoice action. How a vendor user sees their choice to ACCEPT, CONTEST or NO ACTION (i.e., to take no action with respect to approval) is a variable which has been observed changing over time in actual interactions with vendors. The goal here is to capture this behavior in a formula and use it to provide a more realistic understanding of the time it takes a vendor user to accept an invoice and, from this, determine when payments are actually due to the vendor users.

On the Invoice Analysis page of RIS, i.e., the query page (see FIG. 22), when the client users chooses the probability-based analysis, RIS prompts the client user to choose a target vendor user for the analysis or the entire set of vendor users. Then, as in the case of the average analysis, RIS prompts the client user to choose the calendar period for the analysis. When the client user chooses probability analysis of a vendor user, RIS accesses the database of that vendor user's past responses and applies that vendor user's response coefficient to the period of time and associated invoices defined by the client user in the analysis query. The resulting report includes regression plots and numerical probabilities: (1) for the vendor user clicking ACCEPT x days after the invoice is submitted; (2) for payments needed to be made to a vendor user on a particular date for a given invoice or set of invoices; and (3) that a specific amount will be due the chosen vendor user on the day defined in the analysis query.

Although example embodiments have been shown and described in this specification and figures, it would be appreciated by those skilled in the art that changes may be made to the illustrated and/or described example embodiments without departing from their principles and spirit.

1. A method for performing network-based electronic invoicing with reverse invoicing, the method comprising:
presenting an invoice creation screen to a client user, through a client device connected via a network to an electronic invoicing system, the client user being logged-in to the electronic invoicing system;
accepting invoice data input by the client user via the invoice creation screen, the invoice data including, an identifier of a vendor user and an amount payable by the client user to the vendor user for goods and/or services rendered, or to be rendered, to the client use by the vendor user in connection with a first invoice;
generating a first invoice document, corresponding to the first invoice, based on the invoice data input by the client user, the first invoice document including an invoice identifier and the amount payable;
presenting the first invoice document to the client user on an invoice review screen which includes an actuator to post the first invoice document to an account of the vendor user; and
presenting the first invoice document to the vendor user on an invoice approval screen which includes actuators to approve the first invoice document or to contest the first invoice document.

2. (canceled)

3. The method of claim 1, wherein if the vendor user approves the first invoice document, the first invoice document is presented to the client user with an actuator to close a project corresponding, to the first invoice document.

4. The method of claim 3, wherein after the client user closes the project corresponding to the first invoice document, the first invoice document is presented to the vendor user with actuators to approve the first invoice document or to contest the first invoice document.

5. The method of claim 4, wherein if the vendor user approves the first invoice document after the project is closed, the first invoice document is presented to the client user with an approval indication and the first invoice document is entered in a payment queue.

6-9. (canceled)

10. The method of claim 1, wherein if the vendor user contests the first invoice document, the first invoice document is presented to the client user with an actuator to revise the first invoice document.

11. The method of claim 10, wherein if the client user actuates the actuator to revise the first invoice document, the method further comprises presenting to the client user the first invoice document in a form which provides for direct editing of the invoice data and which includes an actuator to post the revised first invoice document.

12. The method of claim 11, wherein if the client user posts a revised first invoice document, the method further comprises presenting to the vendor user a second invoice document, generated based on the revised first invoice document, which includes the invoice data of the revised first invoice document and a new invoice identifier.

13. The method of claim 12, wherein the second invoice document is presented to the vendor user with actuators to approve the second invoice document or to contest the second invoice document.

14. The method of claim 1, wherein if the vendor user contests the first invoice document, the method further comprises accepting comments input by the vendor user.

15. The method of claim 14, wherein the contested first invoice document is presented to the client user with the comments input by the vendor user or an actuator to view the comments input by the vendor user.

16. (canceled)

17. The method of claim 1, wherein the invoice identifier includes an indicator indicating that the first invoice document is a reverse, client-to-vendor, invoice.

18-20. (canceled)

21. The method of claim 1, further comprising presenting to the client user an account summary screen including an activity window presenting a list of invoice-correlated messages.

22. The method of claim 21, wherein each of the invoice-correlated messages includes an identifier comprising an invoice identifier corresponding to an invoice to which the message pertains and a sender identifier corresponding to a vendor user who sent the message.

21. The method of claim 22, wherein the invoice identifier and the sender identifier are concatenated to form the invoice-correlated message identifier as a single data element.

24. The method of claim 22, wherein the invoice identifier of the invoice-correlated message identifier is constrained to values of existing invoices.

25. The method of claim 24, wherein the invoice identifier of the invoice-correlated message identifier is constrained to values of existing invoices when a message is created by verifying the invoice identifier through a lookup of existing invoices in a database.

26. The method of claim 24, wherein the invoice identifier of the invoice-correlated message identifier is constrained to values of existing invoices when a message is created by providing to a creator of the message a selectable menu or a constrained auto-complete list of existing invoices.

27. A system for performing network-based electronic invoicing with reverse invoicing, the system comprising:
a server having a processor, memory, and a network interface, the server being connected to a plurality of client and vendor devices via a network, wherein the server is configured to:
present an invoice creation screen to a client user, through a client device connected via the network to the server, the client user being logged-in to the electronic invoicing system;
accept invoice data input by the client user via the invoice creation screen, the invoice data including an identifier of a vendor user and an amount payable by the client user to the vendor user for goods and/or services rendered, or to be rendered, to the client user by the vendor user in connection with a first invoice;
generate a first invoice document, corresponding to the first invoice, based on the invoice data input, by the client user, the first invoice document including an invoice identifier and the amount payable:
present the first invoice document to the client user on an invoice review screen which includes an actuator to post the first invoice document to an account of the vendor user; and
present the first invoice document to the vendor user on an invoice approval screen which includes actuators to approve the first invoice document or to contest the first invoice document.

28. (canceled)

29. A computer-readable medium storing computer program code, which when executed by a processor, performs a method for network-based electronic invoicing with reverse invoicing, the method comprising:
presenting an invoice creation screen to a client user, through a client device connected via a network to an electronic invoicing system, the client, user being logged-in to the electronic invoicing system;
accepting invoice data input by the client user via the invoice creation screen, the invoice data including an identifier of a vendor user and an amount payable by the client user to the vendor user for goods and/or services rendered, or to be rendered, to the client user by the vendor user in connection with a first invoice;
generating a first invoice document, corresponding to the first invoice, based on the invoice data input by the client user, the first invoice document including an invoice identifier and the amount payable;
presenting the first invoice document to the client user on an invoice review screen which includes an actuator to post the first invoice document to an account of the vendor user; and
presenting the first invoice document to the vendor user on an invoice approval screen which includes actuators to approve the first invoice document or to contest the first invoice document.

30. A method for performing network-based business electronic messaging with constrained project identifiers, the method comprising:
presenting a project-correlated message creation screen to a sending user, through it sending client device connected via a network to an electronic messaging system, the sending user being logged-in to the electronic messaging system;
accepting message data input by the sending user via the project-correlated message creation screen, the message data including a project identifier corresponding to a project to which the message pertains;
generating a message, based on the message data input by the sending user, the message including a message identifier comprising the project identifier corresponding to the project to which the message pertains and a sender identifier corresponding to a sending user who sent the message; and
presenting to the recipient user an activity window presenting a list of project-correlated messages, including the project-correlated message sent by the sending user,
wherein the project identifier of the project-correlated message identifier is constrained to values of existing projects.

31-39. (canceled)
